(19) United States
(12) Patent Application Publication
(10) Pub. No.: US 2026/0300226 A1
(43) Pub. Date: Oct. 1, 2026

(54) Executing File System Operations In Relation To Data Abstraction Units

(71) Applicant: Oracle International Corporation, Redwood Shores, CA (US)

(72) Inventors: Abhijeet Prakash Gole, Cupertino, CA (US); Daniel J. N. Picken, Sunnyvale, CA (US); Gaurav Sharma, San Jose, CA (US); Ravi Lingappa Shamanna, Milpitas, CA (US)

(73) Assignee: Oracle International Corporation, Redwood Shores, CA (US)

(21) Appl. No.: 19/092,171

(22) Filed: Mar. 27, 2025

(51) Int. Cl. G06F 16/16; G06F 16/13

(52) U.S. Cl. CPC G06F 16/16; G06F 16/13

(57) ABSTRACT

A system receives a request from an application to execute a target operation that includes storing a data element in relation to a data abstraction unit. The system determines that storing the data element in relation to the data abstraction unit would result in an aggregate size corresponding to the data abstraction unit exceeding an application-defined size assigned to the first data abstraction unit. Responsive to determining that storing the data element in relation to the data abstraction unit would result in the aggregate size exceeding the application-defined size, the system rejects the request.

### INCORPORATION BY REFERENCE

The following U.S. Patent Applications are hereby incorporated by reference: U.S. patent application Ser. No. 19/092,140, titled “EXECUTING OPERATIONS CORRESPONDING TO TARGET ENTITIES ASSOCIATED WITH FILE SYSTEMS,” filed on Mar. 27, 2025; and U.S. patent application Ser. No. 19/092,153, titled “EXECUTING OPERATIONS CORRESPONDING TO TARGET ENTITIES ASSOCIATED WITH FILE SYSTEMS,” filed on Mar. 27, 2025.

### TECHNICAL FIELD

The present disclosure relates to file systems. More particularly, the present disclosure relates to executing file system operations.

### BACKGROUND

An application interacts with a file system by issuing requests for various operations, such as creating, reading, writing, or deleting files. The application directs requests to the file system through system calls via application programming interfaces (APIs) that serve as an interface between the application and the file system. When the file system receives a request from the application to perform an operation, the file system performs the operation by translating the operation into tasks that the file system performs to complete the operation. These tasks may include allocating space on a storage medium and writing data to the space allocated on the storage medium.

### BRIEF DESCRIPTION OF THE DRAWINGS

The embodiments are illustrated by way of example and not by way of limitation in the figures of the accompanying drawings. References to “an” or “one” embodiment in this disclosure are not necessarily to the same embodiment and refer to at least one embodiment. In the drawings:

FIGS. 1-4 are block diagrams illustrating patterns for implementing a cloud infrastructure as a service system in accordance with one or more embodiments;

FIG. 5 is a hardware system in accordance with one or more embodiments;

FIG. 6 illustrates features of an example system for executing operations associated with a file system in accordance with one or more embodiments;

FIG. 7 schematically depicts example file system data structures in accordance with one or more embodiments; and

FIG. 8 schematically depicts example operations associated with a file system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. CLOUD COMPUTING TECHNOLOGY
3. COMPUTER SYSTEM
4. SYSTEM ARCHITECTURE FOR EXECUTING OPERATIONS ASSOCIATED WITH A FILE SYSTEM
5. EXAMPLE OPERATIONS ASSOCIATED WITH A FILE SYSTEM
6. MISCELLANEOUS; EXTENSIONS

### 1. General Overview

One or more embodiments include a file system that grants or denies requests from an application to store data in relation to a data abstraction unit based on a determination, by the file system, of whether or not storage of the data in in relation to the data abstraction unit would result in an aggregate size corresponding to the data abstraction unit exceeding an application-defined size assigned to the data abstraction unit by the application. In one example, a system receives a request from an application to execute a target operation that includes storing a data element in relation to a data abstraction unit. The system determines an application-defined size assigned to the data abstraction unit by the application. The application may specify the application-defined size when allocating the data structure for storing data elements in relation to the data abstraction unit. The system determines whether executing the target operation would result in an aggregate size corresponding to the data abstraction unit exceeding the application-defined size assigned to the data abstraction unit. When the system determines that executing the target operation would result in the aggregate size corresponding to the data abstraction unit being less than the application-defined size assigned to the data abstraction unit, the system grants the request to execute the target operation. When the system determines that executing the target operation would result in the aggregate size corresponding to the data abstraction unit exceeding the application-defined size assigned to the data abstraction unit, the system rejects the request to execute the target operation.

One or more embodiments described in this Specification and/or recited in the claims may not be included in this General Overview section.

### 2. Cloud Computing Technology

Infrastructure as a Service (IaaS) is an application of cloud computing technology. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components; example services include billing software, monitoring software, logging software, load balancing software, clustering software, etc. Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on the VMs, deploy middleware such as databases, create storage buckets for workloads and backups, and install enterprise software into that VM. Customers can then use the provider's services to perform various functions, including balancing network traffic, troubleshooting application issues, monitoring performance, and managing disaster recovery, etc.

In some cases, a cloud computing model will involve the participation of a cloud provider. The cloud provider may, but need not, be a third-party service that specializes in providing (e.g., offering, renting, selling) IaaS. An entity may also opt to deploy a private cloud, becoming its own provider of infrastructure services.

In some examples, IaaS deployment is the process of implementing a new application, or a new version of an application, onto a prepared application server or other similar device. IaaS deployment may also include the process of preparing the server (e.g., installing libraries, daemons, etc.). The deployment process is often managed by the cloud provider below the hypervisor layer (e.g., the servers, storage, network hardware, and virtualization). Thus, the customer may be responsible for handling (OS), middleware, and/or application deployment such as on self-service virtual machines. The self-service virtual machines can be spun up on demand.

In some examples, IaaS provisioning may refer to acquiring computers or virtual hosts for use, even installing needed libraries or services on them. In most cases, deployment does not include provisioning, and the provisioning may need to be performed first.

In some cases, there are challenges for IaaS provisioning. There is an initial challenge of provisioning the initial set of infrastructure. There is an additional challenge of evolving the existing infrastructure (e.g., adding new services, changing services, removing services, etc.) after the initial provisioning is completed. In some cases, these challenges may be addressed by enabling the configuration of the infrastructure to be defined declaratively. In other words, the infrastructure (e.g., what components are needed and how components interact) can be defined by one or more configuration files. Thus, the overall topology of the infrastructure (e.g., what resources depend on one another and how resources work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up for one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). In some embodiments, infrastructure and resources may be provisioned (manually and/or using a provisioning tool) prior to deployment of code to be executed on the infrastructure. However, in some examples, the infrastructure that will deploy the code may first be set up. In some instances, the provisioning can be done manually, a provisioning tool may be utilized to provision the resources, and/or deployment tools may be utilized to deploy the code once the infrastructure is provisioned.

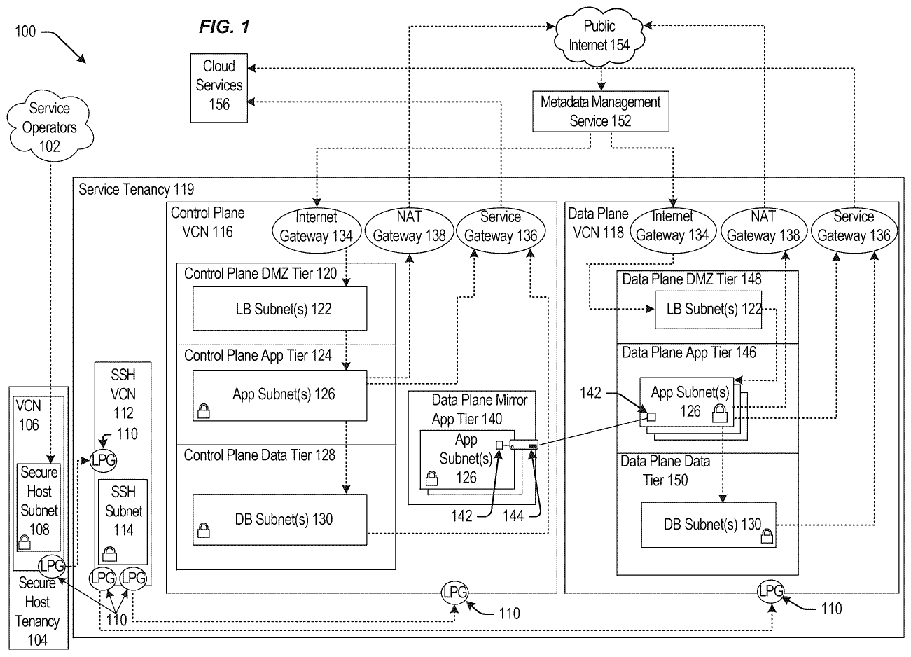

FIG. 1 is a block diagram illustrating an example pattern of an IaaS architecture 100 according to at least one embodiment. Service operators 102 can be communicatively coupled to a secure host tenancy 104 that can include a virtual cloud network (VCN) 106 and a secure host subnet 108. In some examples, the service operators 102 may be using one or more client computing devices, such as portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers, including personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems such as Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 106 and/or the Internet.

The VCN 106 can include a local peering gateway (LPG) 110 that can be communicatively coupled to a secure shell (SSH) VCN 112 via an LPG 110 contained in the SSH VCN 112. The SSH VCN 112 can include an SSH subnet 114, and the SSH VCN 112 can be communicatively coupled to a control plane VCN 116 via the LPG 110 contained in the control plane VCN 116. Also, the SSH VCN 112 can be communicatively coupled to a data plane VCN 118 via an LPG 110. The control plane VCN 116 and the data plane VCN 118 can be contained in a service tenancy 119 that can be owned and/or operated by the IaaS provider.

The control plane VCN 116 can include a control plane demilitarized zone (DMZ) tier 120 that acts as a perimeter network (e.g., portions of a corporate network between the corporate intranet and external networks). The DMZ-based servers may have restricted responsibilities and help keep breaches contained. Additionally, the DMZ tier 120 can include one or more load balancer (LB) subnet(s) 122, a control plane app tier 124 that can include app subnet(s) 126, a control plane data tier 128 that can include database (DB) subnet(s) 130 (e.g., frontend DB subnet(s) and/or backend DB subnet(s)). The LB subnet(s) 122 contained in the control plane DMZ tier 120 can be communicatively coupled to the app subnet(s) 126 contained in the control plane app tier 124 and an Internet gateway 134 that can be contained in the control plane VCN 116. The app subnet(s) 126 can be communicatively coupled to the DB subnet(s) 130 contained in the control plane data tier 128 and a service gateway 136 and a network address translation (NAT) gateway 138. The control plane VCN 116 can include the service gateway 136 and the NAT gateway 138.

The control plane VCN 116 can include a data plane mirror app tier 140 that can include app subnet(s) 126. The app subnet(s) 126 contained in the data plane mirror app tier 140 can include a virtual network interface controller (VNIC) 142 that can execute a compute instance 144. The compute instance 144 can communicatively couple the app subnet(s) 126 of the data plane mirror app tier 140 to app subnet(s) 126 that can be contained in a data plane app tier 146.

The data plane VCN 118 can include the data plane app tier 146, a data plane DMZ tier 148, and a data plane data tier 150. The data plane DMZ tier 148 can include LB subnet(s) 122 that can be communicatively coupled to the app subnet(s) 126 of the data plane app tier 146 and the Internet gateway 134 of the data plane VCN 118. The app subnet(s) 126 can be communicatively coupled to the service gateway 136 of the data plane VCN 118 and the NAT gateway 138 of the data plane VCN 118. The data plane data tier 150 can also include the DB subnet(s) 130 that can be communicatively coupled to the app subnet(s) 126 of the data plane app tier 146.

The Internet gateway 134 of the control plane VCN 116 and of the data plane VCN 118 can be communicatively coupled to a metadata management service 152 that can be communicatively coupled to public Internet 154. Public Internet 154 can be communicatively coupled to the NAT gateway 138 of the control plane VCN 116 and of the data plane VCN 118. The service gateway 136 of the control plane VCN 116 and of the data plane VCN 118 can be communicatively coupled to cloud services 156.

In some examples, the service gateway 136 of the control plane VCN 116 or of the data plane VCN 118 can make application programming interface (API) calls to cloud services 156 without going through public Internet 154. The API calls to cloud services 156 from the service gateway 136 can be one-way; the service gateway 136 can make API calls to cloud services 156, and cloud services 156 can send requested data to the service gateway 136. However, cloud services 156 may not initiate API calls to the service gateway 136.

In some examples, the secure host tenancy 104 can be directly connected to the service tenancy 119. The service tenancy 119 may otherwise be isolated. The secure host subnet 108 can communicate with the SSH subnet 114 through an LPG 110 that may enable two-way communication over an otherwise isolated system. Connecting the secure host subnet 108 to the SSH subnet 114 may give the secure host subnet 108 access to other entities within the service tenancy 119.

The control plane VCN 116 may allow users of the service tenancy 119 to set up or otherwise provision desired resources. Desired resources provisioned in the control plane VCN 116 may be deployed or otherwise used in the data plane VCN 118. In some examples, the control plane VCN 116 can be isolated from the data plane VCN 118, and the data plane mirror app tier 140 of the control plane VCN 116 can communicate with the data plane app tier 146 of the data plane VCN 118 via VNICs 142 that can be contained in the data plane mirror app tier 140 and the data plane app tier 146.

In some examples, users of the system, or customers, can make requests, for example create, read, update, or delete (CRUD) operations, through public Internet 154 that can communicate the requests to the metadata management service 152. The metadata management service 152 can communicate the request to the control plane VCN 116 through the Internet gateway 134. The request can be received by the LB subnet(s) 122 contained in the control plane DMZ tier 120. The LB subnet(s) 122 may determine that the request is valid, and in response, the LB subnet(s) 122 can transmit the request to app subnet(s) 126 contained in the control plane app tier 124. If the request is validated and requires a call to public Internet 154, the call to public Internet 154 may be transmitted to the NAT gateway 138 that can make the call to public Internet 154. Metadata that may be desired to be stored by the request can be stored in the DB subnet(s) 130.

In some examples, the data plane mirror app tier 140 can facilitate direct communication between the control plane VCN 116 and the data plane VCN 118. For example, changes, updates, or other suitable modifications to configuration may be desired to be applied to the resources contained in the data plane VCN 118. Via a VNIC 142, the control plane VCN 116 can directly communicate with, and can thereby execute the changes, updates, or other suitable modifications to configuration to, resources contained in the data plane VCN 118.

In some embodiments, the control plane VCN 116 and the data plane VCN 118 can be contained in the service tenancy 119. In this case, the user, or the customer, of the system may not own or operate either the control plane VCN 116 or the data plane VCN 118. Instead, the IaaS provider may own or operate the control plane VCN 116 and the data plane VCN 118. The control plane VCN 116 and the data plane VCN 118 may be contained in the service tenancy 119. This embodiment can enable isolation of networks that may prevent users or customers from interacting with other users', or other customers', resources. Also, this embodiment may allow users or customers of the system to store databases privately without needing to rely on public Internet 154 for storage.

In other embodiments, the LB subnet(s) 122 contained in the control plane VCN 116 can be configured to receive a signal from the service gateway 136. In this embodiment, the control plane VCN 116 and the data plane VCN 118 may be configured to be called by a customer of the IaaS provider without calling public Internet 154. Customers of the IaaS provider may desire this embodiment since database(s) that the customers use may be controlled by the IaaS provider and may be stored on the service tenancy 119. The service tenancy 119 may be isolated from public Internet 154.

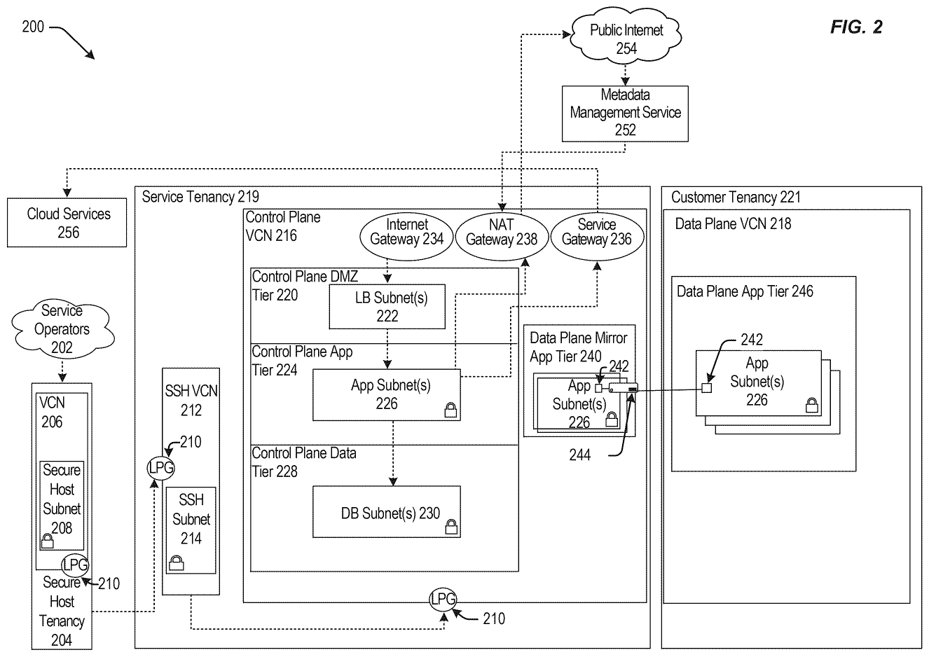

FIG. 2 is a block diagram illustrating another example pattern of an IaaS architecture 200 according to at least one embodiment. Service operators 202 (e.g., service operators 102 of FIG. 1) can be communicatively coupled to a secure host tenancy 204 (e.g., the secure host tenancy 104 of FIG. 1) that can include a virtual cloud network (VCN) 206 (e.g., the VCN 106 of FIG. 1) and a secure host subnet 208 (e.g., the secure host subnet 108 of FIG. 1). The VCN 206 can include a local peering gateway (LPG) 210 (e.g., the LPG 110 of FIG. 1) that can be communicatively coupled to a secure shell (SSH) VCN 212 (e.g., the SSH VCN 112 of FIG. 1) via an LPG 110 contained in the SSH VCN 212. The SSH VCN 212 can include an SSH subnet 214 (e.g., the SSH subnet 114 of FIG. 1), and the SSH VCN 212 can be communicatively coupled to a control plane VCN 216 (e.g., the control plane VCN 116 of FIG. 1) via an LPG 210 contained in the control plane VCN 216. The control plane VCN 216 can be contained in a service tenancy 219 (e.g., the service tenancy 119 of FIG. 1), and the data plane VCN 218 (e.g., the data plane VCN 118 of FIG. 1) can be contained in a customer tenancy 221 that may be owned or operated by users, or customers, of the system.

The control plane VCN 216 can include a control plane DMZ tier 220 (e.g., the control plane DMZ tier 120 of FIG. 1) that can include LB subnet(s) 222 (e.g., LB subnet(s) 122 of FIG. 1), a control plane app tier 224 (e.g., the control plane app tier 124 of FIG. 1) that can include app subnet(s) 226 (e.g., app subnet(s) 126 of FIG. 1), and a control plane data tier 228 (e.g., the control plane data tier 128 of FIG. 1) that can include database (DB) subnet(s) 230 (e.g., similar to DB subnet(s) 130 of FIG. 1). The LB subnet(s) 222 contained in the control plane DMZ tier 220 can be communicatively coupled to the app subnet(s) 226 contained in the control plane app tier 224 and an Internet gateway 234 (e.g., the Internet gateway 134 of FIG. 1) that can be contained in the control plane VCN 216. The app subnet(s) 226 can be communicatively coupled to the DB subnet(s) 230 contained in the control plane data tier 228 and a service gateway 236 (e.g., the service gateway 136 of FIG. 1) and a network address translation (NAT) gateway 238 (e.g., the NAT gateway 138 of FIG. 1). The control plane VCN 216 can include the service gateway 236 and the NAT gateway 238.

The control plane VCN 216 can include a data plane mirror app tier 240 (e.g., the data plane mirror app tier 140 of FIG. 1) that can include app subnet(s) 226. The app subnet(s) 226 contained in the data plane mirror app tier 240 can include a virtual network interface controller (VNIC) 242 (e.g., the VNIC of 142) that can execute a compute instance 244 (e.g., similar to the compute instance 144 of FIG. 1). The compute instance 244 can facilitate communication between the app subnet(s) 226 of the data plane mirror app tier 240 and the app subnet(s) 226 that can be contained in a data plane app tier 246 (e.g., the data plane app tier 146 of FIG. 1) via the VNIC 242 contained in the data plane mirror app tier 240 and the VNIC 242 contained in the data plane app tier 246.

The Internet gateway 234 contained in the control plane VCN 216 can be communicatively coupled to a metadata management service 252 (e.g., the metadata management service 152 of FIG. 1) that can be communicatively coupled to public Internet 254 (e.g., public Internet 154 of FIG. 1). Public Internet 254 can be communicatively coupled to the NAT gateway 238 contained in the control plane VCN 216. The service gateway 236 contained in the control plane VCN 216 can be communicatively coupled to cloud services 256 (e.g., cloud services 156 of FIG. 1).

In some examples, the data plane VCN 218 can be contained in the customer tenancy 221. In this case, the IaaS provider may provide the control plane VCN 216 per customer, and the IaaS provider may, for the customer, set up a unique, compute instance 244 that is contained in the service tenancy 219. Compute instance 244 may allow communication between the control plane VCN 216 contained in the service tenancy 219 and the data plane VCN 218 that is contained in the customer tenancy 221. The compute instance 244 may allow resources provisioned in the control plane VCN 216 that is contained in the service tenancy 219 to be deployed or otherwise used in the data plane VCN 218 that is contained in the customer tenancy 221.

In other examples, the customer of the IaaS provider may have databases that live in the customer tenancy 221. In this example, the control plane VCN 216 can include the data plane mirror app tier 240 that can include app subnet(s) 226. The data plane mirror app tier 240 can reside in the data plane VCN 218, but the data plane mirror app tier 240 may not live in the data plane VCN 218. That is, the data plane mirror app tier 240 may have access to the customer tenancy 221, but the data plane mirror app tier 240 may not exist in the data plane VCN 218 or be owned or operated by the customer of the IaaS provider. The data plane mirror app tier 240 may be configured to make calls to the data plane VCN 218 but may not be configured to make calls to any entity contained in the control plane VCN 216. The customer may desire to deploy or otherwise use resources in the data plane VCN 218 that are provisioned in the control plane VCN 216, and the data plane mirror app tier 240 can facilitate the desired deployment or other usage of resources of the customer.

In some embodiments, the customer of the IaaS provider can apply filters to the data plane VCN 218. In this embodiment, the customer can determine what the data plane VCN 218 can access, and the customer may restrict access to public Internet 254 from the data plane VCN 218. The IaaS provider may not be able to apply filters or otherwise control access of the data plane VCN 218 to any outside networks or databases. Applying filters and controls by the customer onto the data plane VCN 218, contained in the customer tenancy 221, can help isolate the data plane VCN 218 from other customers and from public Internet 254.

In some embodiments, cloud services 256 can be called by the service gateway 236 to access services that may not exist on public Internet 254, on the control plane VCN 216, or on the data plane VCN 218. The connection between cloud services 256 and the control plane VCN 216 or the data plane VCN 218 may not be live or continuous. Cloud services 256 may exist on a different network owned or operated by the IaaS provider. Cloud services 256 may be configured to receive calls from the service gateway 236 and may be configured to not receive calls from public Internet 254. Some cloud services 256 may be isolated from other cloud services 256, and the control plane VCN 216 may be isolated from cloud services 256 that may not be in the same region as the control plane VCN 216. For example, the control plane VCN 216 may be located in “Region 1,” and cloud service “Deployment 1” may be located in Region 1 and in “Region 2.” If a call to Deployment 1 is made by the service gateway 236 contained in the control plane VCN 216 located in Region 1, the call may be transmitted to Deployment 1 in Region 1. In this example, the control plane VCN 216, or Deployment 1 in Region 1, may not be communicatively coupled to, or otherwise in communication with, Deployment 1 in Region 2.

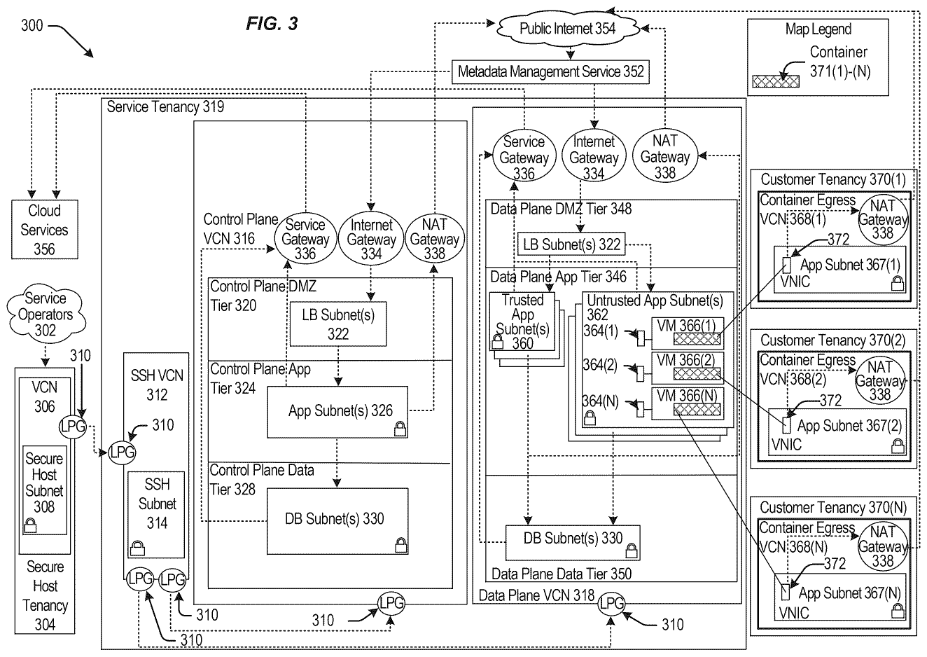

FIG. 3 is a block diagram illustrating another example pattern of an IaaS architecture 300 according to at least one embodiment. Service operators 302 (e.g., service operators 102 of FIG. 1) can be communicatively coupled to a secure host tenancy 304 (e.g., the secure host tenancy 104 of FIG. 1) that can include a virtual cloud network (VCN) 306 (e.g., the VCN 106 of FIG. 1) and a secure host subnet 308 (e.g., the secure host subnet 108 of FIG. 1). The VCN 306 can include an LPG 310 (e.g., the LPG 110 of FIG. 1) that can be communicatively coupled to an SSH VCN 312 (e.g., the SSH VCN 112 of FIG. 1) via an LPG 310 contained in the SSH VCN 312. The SSH VCN 312 can include an SSH subnet 314 (e.g., the SSH subnet 114 of FIG. 1), and the SSH VCN 312 can be communicatively coupled to a control plane VCN 316 (e.g., the control plane VCN 116 of FIG. 1) via an LPG 310 contained in the control plane VCN 316 and to a data plane VCN 318 (e.g., the data plane VCN 118 of FIG. 1) via an LPG 310 contained in the data plane VCN 318. The control plane VCN 316 and the data plane VCN 318 can be contained in a service tenancy 319 (e.g., the service tenancy 119 of FIG. 1).

The control plane VCN 316 can include a control plane DMZ tier 320 (e.g., the control plane DMZ tier 120 of FIG. 1) that can include load balancer (LB) subnet(s) 322 (e.g., LB subnet(s) 122 of FIG. 1), a control plane app tier 324 (e.g., the control plane app tier 124 of FIG. 1) that can include app subnet(s) 326 (e.g., similar to app subnet(s) 126 of FIG. 1), and a control plane data tier 328 (e.g., the control plane data tier 128 of FIG. 1) that can include DB subnet(s) 330. The LB subnet(s) 322 contained in the control plane DMZ tier 320 can be communicatively coupled to the app subnet(s) 326 contained in the control plane app tier 324 and to an Internet gateway 334 (e.g., the Internet gateway 134 of FIG. 1) that can be contained in the control plane VCN 316, and the app subnet(s) 326 can be communicatively coupled to the DB subnet(s) 330 contained in the control plane data tier 328 and to a service gateway 336 (e.g., the service gateway of FIG. 1) and a network address translation (NAT) gateway 338 (e.g., the NAT gateway 138 of FIG. 1). The control plane VCN 316 can include the service gateway 336 and the NAT gateway 338.

The data plane VCN 318 can include a data plane app tier 346 (e.g., the data plane app tier 146 of FIG. 1), a data plane DMZ tier 348 (e.g., the data plane DMZ tier 148 of FIG. 1), and a data plane data tier 350 (e.g., the data plane data tier 150 of FIG. 1). The data plane DMZ tier 348 can include LB subnet(s) 322 that can be communicatively coupled to trusted app subnet(s) 360, untrusted app subnet(s) 362 of the data plane app tier 346, and the Internet gateway 334 contained in the data plane VCN 318. The trusted app subnet(s) 360 can be communicatively coupled to the service gateway 336 contained in the data plane VCN 318, the NAT gateway 338 contained in the data plane VCN 318, and DB subnet(s) 330 contained in the data plane data tier 350. The untrusted app subnet(s) 362 can be communicatively coupled to the service gateway 336 contained in the data plane VCN 318 and DB subnet(s) 330 contained in the data plane data tier 350. The data plane data tier 350 can include DB subnet(s) 330 that can be communicatively coupled to the service gateway 336 contained in the data plane VCN 318.

The untrusted app subnet(s) 362 can include one or more primary VNICs 364(1)-(N) that can be communicatively coupled to tenant virtual machines (VMs) 366(1)-(N). Tenant(s) VM 366(1)-(N) can be communicatively coupled to a respective app subnet 367(1)-(N) that can be contained in respective container egress VCNs 368(1)-(N) that can be contained in respective customer tenancies 380(1)-(N). Respective secondary VNICs 372(1)-(N) can facilitate communication between the untrusted app subnet(s) 362 contained in the data plane VCN 318 and the app subnet contained in the container egress VCNs 368(1)-(N). Container egress VCNs 368(1)-(N) can include a NAT gateway 338 that can be communicatively coupled to public Internet 354 (e.g., public Internet 154 of FIG. 1).

The Internet gateway 334 contained in the control plane VCN 316 and contained in the data plane VCN 318 can be communicatively coupled to a metadata management service 352 (e.g., the metadata management service 152 of FIG. 1) that can be communicatively coupled to public Internet 354. Public Internet 354 can be communicatively coupled to the NAT gateway 338 contained in the control plane VCN 316 and contained in the data plane VCN 318. The service gateway 336 contained in the control plane VCN 316 and contained in the data plane VCN 318 can be communicatively couple to cloud services 356.

In some embodiments, the data plane VCN 318 can be integrated with customer tenancies 380. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether or not to run code given to the IaaS provider by the customer.

In some examples, the customer of the IaaS provider may grant temporary network access to the IaaS provider and request a function to be attached to the data plane app tier 346. Code to run the function may be executed in the VMs 366(1)-(N), and the code may not be configured to run anywhere else on the data plane VCN 318. VM 366(1)-(N) may be connected to one customer tenancy 380. Respective containers 381(1)-(N) contained in the VMs 366(1)-(N) may be configured to run the code. In this case, there can be a dual isolation (e.g., the containers 381(1)-(N) running code), where the containers 381(1)-(N) may be contained in at least the VM 366(1)-(N) that are contained in the untrusted app subnet(s) 362) that may help prevent incorrect or otherwise undesirable code from damaging the network of the IaaS provider or from damaging a network of a different customer. The containers 381(1)-(N) may be communicatively coupled to the customer tenancy 380 and may be configured to transmit or receive data from the customer tenancy 380. The containers 381(1)-(N) may not be configured to transmit or receive data from any other entity in the data plane VCN 318. Upon completion of running the code, the IaaS provider may kill or otherwise dispose of the containers 381(1)-(N).

In some embodiments, the trusted app subnet(s) 360 may run code that may be owned or operated by the IaaS provider. In this embodiment, the trusted app subnet(s) 360 may be communicatively coupled to the DB subnet(s) 330 and be configured to execute CRUD operations in the DB subnet(s) 330. The untrusted app subnet(s) 362 may be communicatively coupled to the DB subnet(s) 330, but in this embodiment, the untrusted app subnet(s) may be configured to execute read operations in the DB subnet(s) 330. The containers 381(1)-(N) that can be contained in the VM 366(1)-(N) of the customer and that may run code from the customer may not be communicatively coupled with the DB subnet(s) 330.

In other embodiments, the control plane VCN 316 and the data plane VCN 318 may not be directly communicatively coupled. In this embodiment, there may be no direct communication between the control plane VCN 316 and the data plane VCN 318. However, communication can occur indirectly through at least one method. An LPG 310 may be established by the IaaS provider that can facilitate communication between the control plane VCN 316 and the data plane VCN 318. In another example, the control plane VCN 316 or the data plane VCN 318 can make a call to cloud services 356 via the service gateway 336. For example, a call to cloud services 356 from the control plane VCN 316 can include a request for a service that can communicate with the data plane VCN 318.

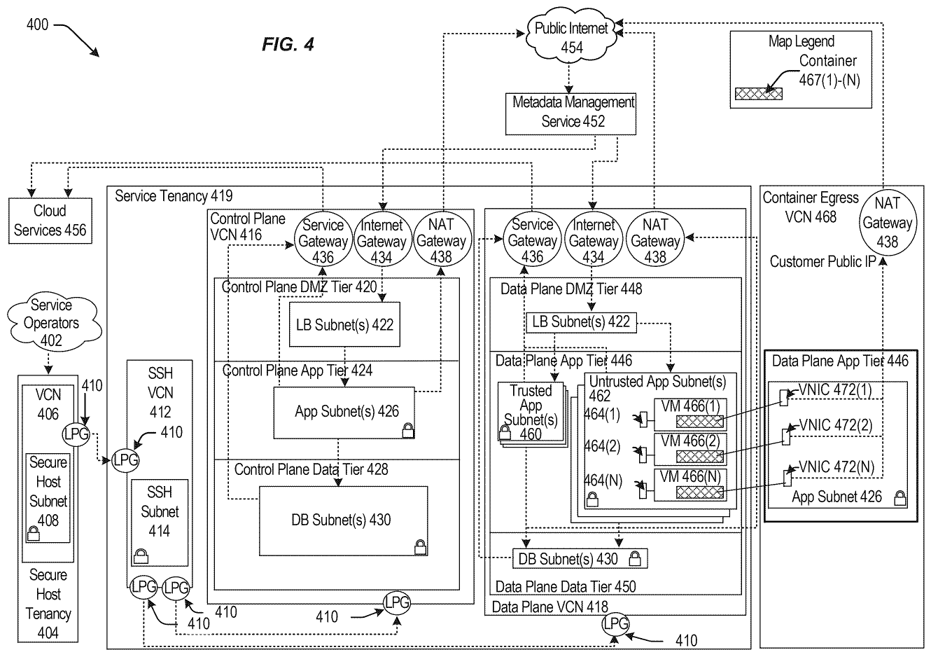

FIG. 4 is a block diagram illustrating another example pattern of an IaaS architecture 400 according to at least one embodiment. Service operators 402 (e.g., service operators 102 of FIG. 1) can be communicatively coupled to a secure host tenancy 404 (e.g., the secure host tenancy 104 of FIG. 1) that can include a virtual cloud network (VCN) 406 (e.g., the VCN 106 of FIG. 1) and a secure host subnet 408 (e.g., the secure host subnet 108 of FIG. 1). The VCN 406 can include an LPG 410 (e.g., the LPG 110 of FIG. 1) that can be communicatively coupled to an SSH VCN 412 (e.g., the SSH VCN 112 of FIG. 1) via an LPG 410 contained in the SSH VCN 412. The SSH VCN 412 can include an SSH subnet 414 (e.g., the SSH subnet 114 of FIG. 1), and the SSH VCN 412 can be communicatively coupled to a control plane VCN 416 (e.g., the control plane VCN 116 of FIG. 1) via an LPG 410 contained in the control plane VCN 416 and to a data plane VCN 418 (e.g., the data plane VCN 118 of FIG. 1) via an LPG 410 contained in the data plane VCN 418. The control plane VCN 416 and the data plane VCN 418 can be contained in a service tenancy 419 (e.g., the service tenancy 119 of FIG. 1).

The control plane VCN 416 can include a control plane DMZ tier 420 (e.g., the control plane DMZ tier 120 of FIG. 1) that can include LB subnet(s) 422 (e.g., LB subnet(s) 122 of FIG. 1), a control plane app tier 424 (e.g., the control plane app tier 124 of FIG. 1) that can include app subnet(s) 426 (e.g., app subnet(s) 126 of FIG. 1), and a control plane data tier 428 (e.g., the control plane data tier 128 of FIG. 1) that can include DB subnet(s) 430 (e.g., DB subnet(s) 330 of FIG. 3). The LB subnet(s) 422 contained in the control plane DMZ tier 420 can be communicatively coupled to the app subnet(s) 426 contained in the control plane app tier 424 and to an Internet gateway 434 (e.g., the Internet gateway 134 of FIG. 1) that can be contained in the control plane VCN 416, and the app subnet(s) 426 can be communicatively coupled to the DB subnet(s) 430 contained in the control plane data tier 428 and to a service gateway 436 (e.g., the service gateway of FIG. 1) and a network address translation (NAT) gateway 438 (e.g., the NAT gateway 138 of FIG. 1). The control plane VCN 416 can include the service gateway 436 and the NAT gateway 438.

The data plane VCN 418 can include a data plane app tier 446 (e.g., the data plane app tier 146 of FIG. 1), a data plane DMZ tier 448 (e.g., the data plane DMZ tier 148 of FIG. 1), and a data plane data tier 450 (e.g., the data plane data tier 150 of FIG. 1). The data plane DMZ tier 448 can include LB subnet(s) 422 that can be communicatively coupled to trusted app subnet(s) 460 (e.g., trusted app subnet(s) 360 of FIG. 3) and untrusted app subnet(s) 462 (e.g., untrusted app subnet(s) 362 of FIG. 3) of the data plane app tier 446 and the Internet gateway 434 contained in the data plane VCN 418. The trusted app subnet(s) 460 can be communicatively coupled to the service gateway 436 contained in the data plane VCN 418, the NAT gateway 438 contained in the data plane VCN 418, and DB subnet(s) 430 contained in the data plane data tier 450. The untrusted app subnet(s) 462 can be communicatively coupled to the service gateway 436 contained in the data plane VCN 418 and DB subnet(s) 430 contained in the data plane data tier 450. The data plane data tier 450 can include DB subnet(s) 430 that can be communicatively coupled to the service gateway 436 contained in the data plane VCN 418.

The untrusted app subnet(s) 462 can include primary VNICs 464(1)-(N) that can be communicatively coupled to tenant virtual machines (VMs) 466(1)-(N) residing within the untrusted app subnet(s) 462. Tenant VM 466(1)-(N) can run code in a respective container 467(1)-(N) and be communicatively coupled to an app subnet 426 that can be contained in a data plane app tier 446 that can be contained in a container egress VCN 468. Respective secondary VNICs 472(1)-(N) can facilitate communication between the untrusted app subnet(s) 462 contained in the data plane VCN 418 and the app subnet contained in the container egress VCN 468. The container egress VCN can include a NAT gateway 438 that can be communicatively coupled to public Internet 454 (e.g., public Internet 154 of FIG. 1).

The Internet gateway 434 contained in the control plane VCN 416 and contained in the data plane VCN 418 can be communicatively coupled to a metadata management service 452 (e.g., the metadata management service 152 of FIG. 1) that can be communicatively coupled to public Internet 454. Public Internet 454 can be communicatively coupled to the NAT gateway 438 contained in the control plane VCN 416 and contained in the data plane VCN 418. The service gateway 436 contained in the control plane VCN 416 and contained in the data plane VCN 418 can be communicatively coupled to cloud services 456.

In some examples, the pattern illustrated by the architecture of block diagram 400 of FIG. 4 may be considered an exception to the pattern illustrated by the architecture of block diagram 300 of FIG. 3 and may be desirable for a customer of the IaaS provider if the IaaS provider cannot directly communicate with the customer (e.g., a disconnected region). The respective containers 467(1)-(N) that are contained in the VMs 466(1)-(N) for customers can be accessed in real-time by the customer. The containers 467(1)-(N) may be configured to make calls to respective secondary VNICs 472(1)-(N) contained in app subnet(s) 426 of the data plane app tier 446 that can be contained in the container egress VCN 468. The secondary VNICs 472(1)-(N) can transmit the calls to the NAT gateway 438 that may transmit the calls to public Internet 454. In this example, the containers 467(1)-(N) that can be accessed in real time by the customer can be isolated from the control plane VCN 416 and can be isolated from other entities contained in the data plane VCN 418. The containers 467(1)-(N) may also be isolated from resources from other customers.

In other examples, the customer can use the containers 467(1)-(N) to call cloud services 456. In this example, the customer may run code in the containers 467(1)-(N) that request a service from cloud services 456. The containers 467(1)-(N) can transmit this request to the secondary VNICs 472(1)-(N) that can transmit the request to the NAT gateway that can transmit the request to public Internet 454. Public Internet 454 can transmit the request to LB subnet(s) 422 contained in the control plane VCN 416 via the Internet gateway 434. In response to determining the request is valid, the LB subnet(s) can transmit the request to app subnet(s) 426 that can transmit the request to cloud services 456 via the service gateway 436.

It should be appreciated that IaaS architectures 100, 200, 300, and 400 may include components that are different and/or additional to the components shown in the figures. Further, the embodiments shown in the figures represent non-exhaustive examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. The nodes may be local to and/or remote from one other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network such as a physical network. A node in an overlay network corresponds to a respective node in the underlying network. Hence, a node in an overlay network is associated with both an overlay address (to address to the overlay node) and an underlay address (to address the underlay node that implements the overlay node). An overlay node may be a digital device and/or a software process, such as a virtual machine, an application instance, or a thread. A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an API.

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of one another. Network resources are dynamically assigned to the requests and/or clients on an on-demand basis. Network resources assigned to a request and/or client may be scaled up or down based on one or more of the following: (a) the computing services requested by a particular client, (b) the aggregated computing services requested by a particular tenant, or (c) the aggregated computing services requested of the computer network. Such a computer network may be referred to as a “cloud network.”

In an embodiment, a service provider provides a cloud network to one or more end users. Various service models may be implemented by the cloud network, including, but not limited, to Software-as-a-Service (Saas), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, a private cloud, a public cloud, and a hybrid cloud. In a private cloud, network resources are provisioned for exclusive use by a particular group of one or more entities; the term “entity” as used herein refers to a corporation, organization, person, or other entity. The network resources may be local to and/or remote from the premises of the particular group of entities. In a public cloud, cloud resources are provisioned for multiple entities that are independent from one another (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on one other. A call from an application at the private cloud to an application at the public cloud (and vice versa) may be executed through the interface.

In an embodiment, tenants of a multi-tenant computer network are independent of one another. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with other tenants. Various tenant isolation approaches may be used.

In an embodiment, a tenant is associated with a tenant ID. The network resource of the multi-tenant computer network is tagged with a tenant ID. A tenant is permitted access to a particular network resource when the tenant and the particular network resources are associated with a same tenant ID.

In an embodiment, a tenant is associated with a tenant ID. An application, implemented by the computer network, is tagged with a tenant ID. Additionally, or alternatively, data structures and/or datasets, stored by the computer network, are tagged with a tenant ID. A tenant is permitted access to a particular application, data structure, and/or dataset when the tenant and the particular application, data structure, and/or dataset are associated with a same tenant ID.

As an example, a database implemented by a multi-tenant computer network may be tagged with a tenant ID. A tenant associated with the corresponding tenant ID may access data of a particular database. As another example, an entry in a database implemented by a multi-tenant computer network may be tagged with a tenant ID. A tenant associated with the corresponding tenant ID may access data of a particular entry. However, multiple tenants may share the database.

In an embodiment, a subscription list identifies a set of tenants, and, for a particular tenant, a set of applications that the particular tenant is authorized to access. For a particular application, a list of tenant IDs of tenants authorized to access the particular application is stored. A tenant is permitted access to a particular application when the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 3. Computer System

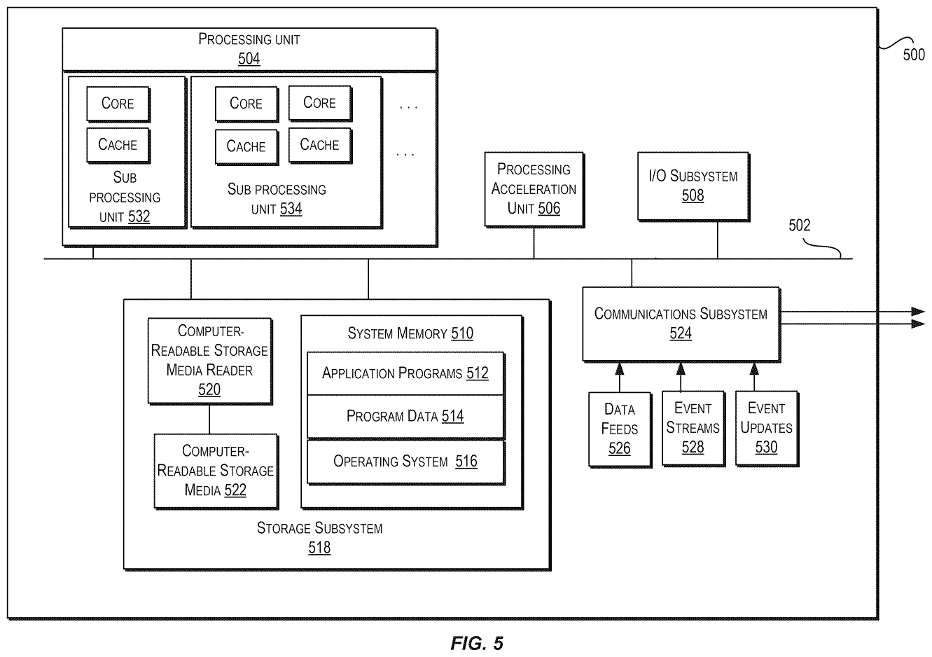

FIG. 5 illustrates an example computer system 500. An embodiment of the disclosure may be implemented upon the computer system 500. As shown in FIG. 5, computer system 500 includes a processing unit 504 that communicates with peripheral subsystems via a bus subsystem 502. These peripheral subsystems may include a processing acceleration unit 506, an I/O subsystem 508, a storage subsystem 518, and a communications subsystem 524. Storage subsystem 518 includes tangible computer-readable storage media 522 and a system memory 510.

Bus subsystem 502 provides a mechanism for letting the various components and subsystems of computer system 500 to communicate with one another as intended. Although bus subsystem 502 is shown schematically as a single bus, alternative embodiments of the bus subsystem may utilize multiple buses. Bus subsystem 502 may be any of several types of bus structures, including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Additionally, such architectures may be implemented as a Mezzanine bus manufactured to the IEEE P1386.1 standard.

Processing unit 504 controls the operation of computer system 500. Processing unit 504 can be implemented as one or more integrated circuits (e.g., a conventional microprocessor or microcontroller). One or more processors may be included in processing unit 504. These processors may include single core or multicore processors. In certain embodiments, processing unit 504 may be implemented as one or more independent processing units 532 and/or 534 with single or multicore processors included in the processing unit. In other embodiments, processing unit 504 may also be implemented as a quad-core processing unit formed by integrating two dual-core processors into a single chip.

In various embodiments, processing unit 504 can execute a variety of programs in response to program code and can maintain multiple concurrently executing programs or processes. At any given time, the program code to be executed can be wholly or partially resident in processing unit 504 and/or in storage subsystem 518. Through suitable programming, processing unit 504 can provide various functionalities described above. Computer system 500 may additionally include a processing acceleration unit 506 that can include a digital signal processor (DSP), a special-purpose processor, and/or the like.

I/O subsystem 508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include medical imaging input devices such as computed tomography, magnetic resonance imaging, position emission tomography, or medical ultrasonography devices. User interface input devices may also include audio input devices such as MIDI keyboards, digital musical instruments, and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include any type of device and mechanism for outputting information from computer system 500 to a user or other computer. For example, user interface output devices may include, without limitation, a variety of display devices that visually convey text, graphics, and audio/video information, such as monitors, printers, speakers, headphones, automotive navigation systems, plotters, voice output devices, and modems.

Computer system 500 may comprise a storage subsystem 518 that provides a tangible non-transitory computer-readable media for storing software and data constructs that provide the functionality of the embodiments described in this disclosure. The non-transitory computer-readable media includes instructions that cause performance of operations described herein. The software can include programs, code modules, instructions, scripts, etc., that when executed by one or more cores or processors of processing unit 504 provide the functionality described above. Storage subsystem 518 may also provide a repository for storing data used in accordance with the present disclosure.

As depicted in the example in FIG. 5, storage subsystem 518 can include various components, including a system memory 510, computer-readable storage media 522, and a computer readable storage media reader 520. System memory 510 may store program instructions, such as application programs 512, that are loadable and executable by processing unit 504. System memory 510 may also store data, such as program data 514, that is used during the execution of the instructions and/or data that is generated during the execution of the program instructions. Various programs may be loaded into system memory 510 including, but not limited to, client applications, Web browsers, mid-tier applications, relational database management systems (RDBMS), virtual machines, containers, etc.

System memory 510 may also store an operating system 516. Examples of operating system 516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 500 executes one or more virtual machines, the virtual machines along with their guest operating systems (GOSs) may be loaded into system memory 510 and executed by one or more processors or cores of processing unit 504.

System memory 510 can come in different configurations depending upon the type of computer system 500. For example, system memory 510 may be volatile memory (such as random-access memory (RAM)) and/or non-volatile memory (such as read-only memory (ROM), flash memory, etc.). Different types of RAM configurations may be provided, including a static random-access memory (SRAM), a dynamic random-access memory (DRAM), and others. In some implementations, system memory 510 may include a basic input/output system (BIOS) containing basic routines that help to transfer information between elements within computer system 500 such as during start-up.

Computer-readable storage media 522 may represent remote, local, fixed, and/or removable storage devices plus storage media for temporarily and/or more permanently containing, storing, computer-readable information for use by computer system 500, including instructions executable by processing unit 504 of computer system 500.

Computer-readable storage media 522 can include any appropriate media known or used in the art, including storage media and communication media, such as but not limited to volatile and non-volatile, removable, and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 522 may include, but is not limited to, Zip® drives, flash memory cards, universal serial bus (USB) flash drives, secure digital (SD) cards, DVD disks, digital video tape, and the like. Computer-readable storage media 522 may also include solid-state drives (SSD) based on non-volatile memory, such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Machine-readable instructions executable by one or more processors or cores of processing unit 504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 524 provides an interface to other computer systems and networks. Communications subsystem 524 serves as an interface for receiving data from and transmitting data to other systems from computer system 500. For example, communications subsystem 524 may enable computer system 500 to connect to one or more devices via the Internet. In some embodiments, communications subsystem 524 can include radio frequency (RF) transceiver components to access wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments, communications subsystem 524 can provide wired network connectivity (e.g., Ethernet) in addition to or instead of a wireless interface.

In some embodiments, communications subsystem 524 may also receive input communication in the form of structured and/or unstructured data feeds 526, event streams 528, event updates 530, and the like on behalf of one or more users who may use computer system 500.

By way of example, communications subsystem 524 may be configured to receive data feeds 526 in real-time from users of social networks and/or other communication services, such as Twitter® feeds, Facebook® updates, web feeds such as Rich Site Summary (RSS) feeds, and/or real-time updates from one or more third party information sources.

Additionally, communications subsystem 524 may be configured to receive data in the form of continuous data streams. The continuous data streams may include event streams 528 of real-time events and/or event updates 530 that may be continuous or unbounded in nature with no explicit end. Examples of applications that generate continuous data may include sensor data applications, financial tickers, network performance measuring tools (e.g., network monitoring and traffic management applications), clickstream analysis tools, automobile traffic monitoring, and the like.

Communications subsystem 524 may also be configured to output the structured and/or unstructured data feeds 526, event streams 528, event updates 530, and the like to one or more databases that may be in communication with one or more streaming data source computers coupled to computer system 500.

Computer system 500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 500 depicted in FIG. 5 is intended as a non-limiting example. Many other configurations having more or fewer components than the system depicted in FIG. 5 are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

### 4. System Architecture for Executing Operations Associated with a File System

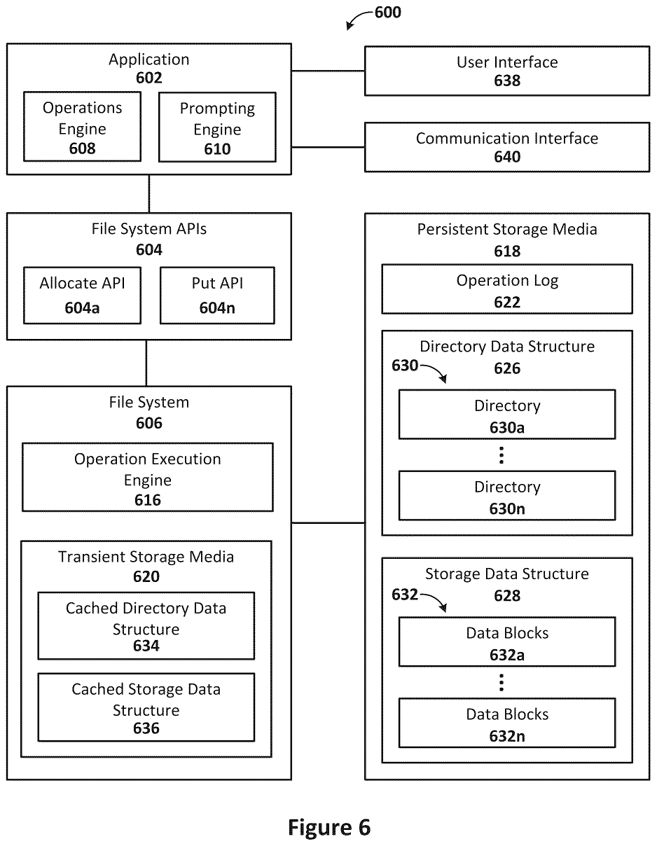

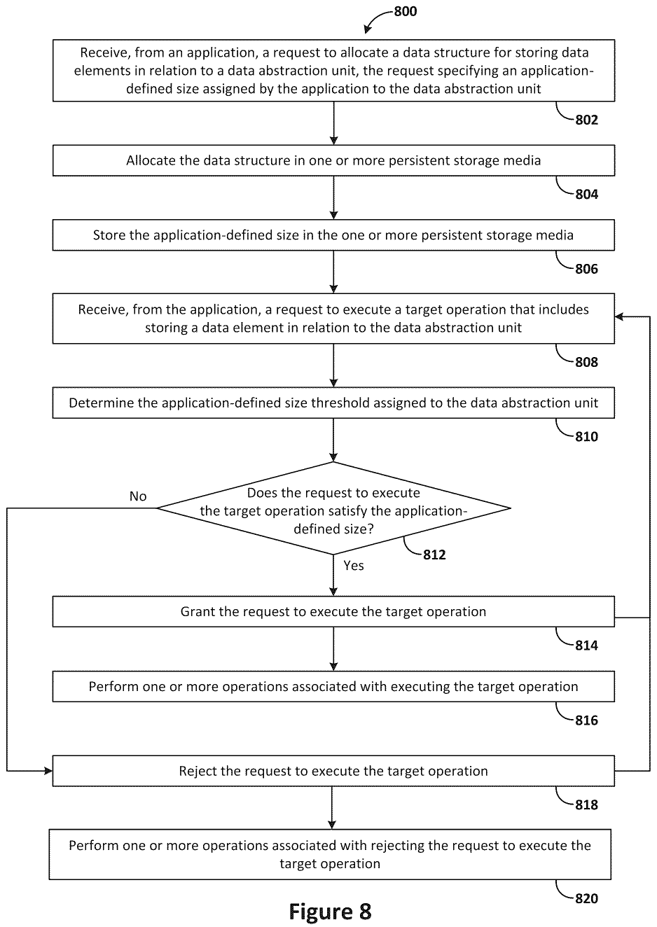

FIG. 6 illustrates features of an example system 600 for executing operations associated with a file system in accordance with one or more embodiments. The system may be utilized to store data elements in relation to data abstraction units. As used herein, the term “data abstraction unit” refers to a logical abstraction representing a unit of data that includes one or more data elements. A data abstraction unit may include unstructured data. A data abstraction unit may include an object or a blob in an object-based storage system. The data elements stored in relation to a data abstraction unit may include one or more of the following: files, databases, binaries, disk images, container images, virtual machine snapshots, or executable. Metadata associated with a data abstraction unit may be stored in a separate data structure from the data abstraction unit. In one or more embodiments, the system 600 refers to hardware and/or software configured to perform operations described herein. Examples of operations are described below with reference to FIG. 8. In one example, the system described with reference to FIG. 6 may include one or more features described above in Section 2, titled “Cloud Computing Technology,” and/or in Section 3, titled “Computer System.”

In one or more embodiments, the system 600 may include more or fewer components than the components described with reference to FIG. 6. The components described with reference to FIG. 6 may be local to or remote from each other. The components described with reference to FIG. 6 may be implemented in software and/or hardware. The components of system 600 may be distributed over multiple applications and/or machines. Multiple components may be combined into one application and/or machine. Operations described with respect to one component may instead be performed by another component.

### A. Example File Systems And Related Components

As shown in FIG. 6, the system 600 includes at least one application 602, one or more file system APIs 604, and a file system 606. The system 600 may represent a portion of a cloud computing environment. The one or more file system APIs 604 serve as an intermediary between the application 602 and the file system 606. The file system 606 organizes data as a hierarchy of directories and files. In one example, the file system stores metadata associated with files separately from file contents. The file system 606 executes operations that appear to have atomicity from the perspective of the application 602. The file system 606 includes software that executes operations associated with management of storage media and data stored on the storage media. The operations executed by the file system include storing data on storage media, retrieving data from storage media, modifying data, and deleting data. Additionally, the file system maintains metadata for managing the data stored on the storage media and the operations executed by the file system.

The file system 606 executes operations in response to requests from the application 602. The application 602 includes software that performs specific tasks or operations, and in connection with those specific tasks or operations, directs requests to the file system 606 to execute file system operations, such as storing, retrieving, modifying, or deleting data. The application 602 includes an operations engine 608 that executes specific tasks or operations of the application and a prompting engine 610 that directs requests to the file system 606 for the file system 606 to execute file system operations. The operations engine 608 may execute application operations, such as one or more of the following: data processing, configuration, content generation, content delivery, data synchronization, backup and recovery, data replication, task coordination, file sharing, service discovery, user authentication, fault tolerance, or data recovery. Additionally, or alternatively, the application operations may be associated with one or more of the following: business processes, customer relationships, order processing, real-time analytics, machine learning, artificial intelligence, document management, employee management, communications, or financial services. The prompting engine 610 may direct requests to the file system 606 in connection with application operations executed by the operations engine 608.

In one example, the application 602 executes a workflow that includes a set of application operations executed by the operations engine 608. During execution of the workflow, the application 602 encounters an application operation that involves performance of a file system operation, such as storing, retrieving, modifying, or deleting data. The application operation may depend on successful execution of the file system operation. The application 602 may utilize the prompting engine 610 to direct a request to the file system 606 for the file system 606 to execute one or more file system operations. The application 602 may pause or wait for a response from the file system. The request from the application 602 to the file system 606 may be blocking with respect to at least a portion of the application operations in the workflow. The prompting engine 610 may direct the request to the file system 606 via a blocking call. The blocking call may prevent at least some application operations from proceeding until the application 602 receives a response to the blocking call that satisfies one or more conditions of the blocking call. For example, when a blocking call is waiting for a file system operation, such as storing, retrieving, modifying, or deleting data, the one or more conditions of the blocking call may depend on successful execution of the file system operation.

In one example, the application 602 releases the blocking call when the application 602 receives a response that indicates that the file system operation is successfully completed. Additionally, or alternatively, the application 602 may release the blocking call when the application 602 receives a response that allows the application 602 to depend on successful execution of the file system operation. The application 602 may be unaware, based on the response from the file system 606, whether or not the file system operation has been completed as of the time when the application 602 receives the response. In one example, the file system 606 performs the file system operation after returning the response to the request from the application 602. The file system 606 stores metadata in persistent memory that allows the file system 606 to execute the file system operation at a later time. Because the metadata is stored in persistent memory, the application 602 can depend on successful execution of the file system operation based on the response. When the application 602 receives a response that satisfies one or more conditions of the request, the application 602 resumes execution of the workflow, for example, by releasing the blocking call. Upon resuming execution of the workflow, the application 602 executes additional application operations. In one example, the application operations executed after the response from the file system 606 depend on a result of the file system operation corresponding to the response that satisfied the one or more conditions for the application 602 to resume execution of the workflow, for example, by releasing the blocking call.

The file system APIs 604 allow the application 602 to direct requests to the file system 606. The system 600 exposes the file system APIs 604 to the application 602, for example, through system libraries and/or through a runtime environment. The file system APIs 604 allow the application 602 to interact with the file system 606. The application 602 may access the file system APIs 604 through function calls for requesting the file system 606 to execute target operations, such as storing, retrieving, modifying, or deleting data. In one example, the system 600 translates the calls from the application 602 sent via the file system APIs 604 into specific instructions that are executable by the file system 606. The file system APIs 604 may include particular APIs for the application 602 to direct requests to the file system 606 for the file system 606 to execute particular target operations and/or combinations of target operations. As shown in FIG. 6, in one example, the file system APIs 604 include an allocate API 604a and a put API 604n.

The allocate API 604a enables the application to direct a request to the file system 606 for the file system 606 to execute one or more target operations associated with an operation type of “allocate.” An allocate operation may include allocating a data structure for storing data elements in relation to a data abstraction unit. Additionally, an allocate operation may include defining an application-defined size assigned to the data abstraction unit by the application. In one example, the data elements represent at least a portion of a file or a log. The data elements may include additional data and/or updates to the file or log.

The put API 604n enables the application 602 to direct a request to the file system 606 for the file system 606 to execute one or more target operations associated with an operation type of “put.” A put operation may include writing, uploading, and/or inserting data into a data structure stored in one or more storage media. Additionally, or alternatively, a put operation may include modifying data stored in a data structure. The put operation may include writing, uploading, inserting, or modifying data in relation to a data abstraction unit.

Referring further to FIG. 6, the file system 606 includes an operation execution engine 616. The operation execution engine 616 executes file system operations in response to requests from the application 602. The file system operations may include one or more operations associated with a target operation requested by the application 602, such as storing, retrieving, modifying, or deleting data in one or more storage media. The operation execution engine 616 may determine whether a request from the application 602 to execute a file system operation in relation to a data abstraction unit would result in an aggregate size corresponding to the data abstraction unit exceeding the application-defined size assigned to the data abstraction unit by the application 602. When the operation execution engine 616 determines that executing the file system operation would result in the aggregate size corresponding to the data abstraction unit being less than the application-defined size assigned to the data abstraction unit, the system grants the request to execute the file system operation. When the operation execution engine 616 determines that executing the file system operation would result in the aggregate size corresponding to the data abstraction unit exceeding the application-defined size assigned to the data abstraction unit, the system rejects the request to execute the file system operation.

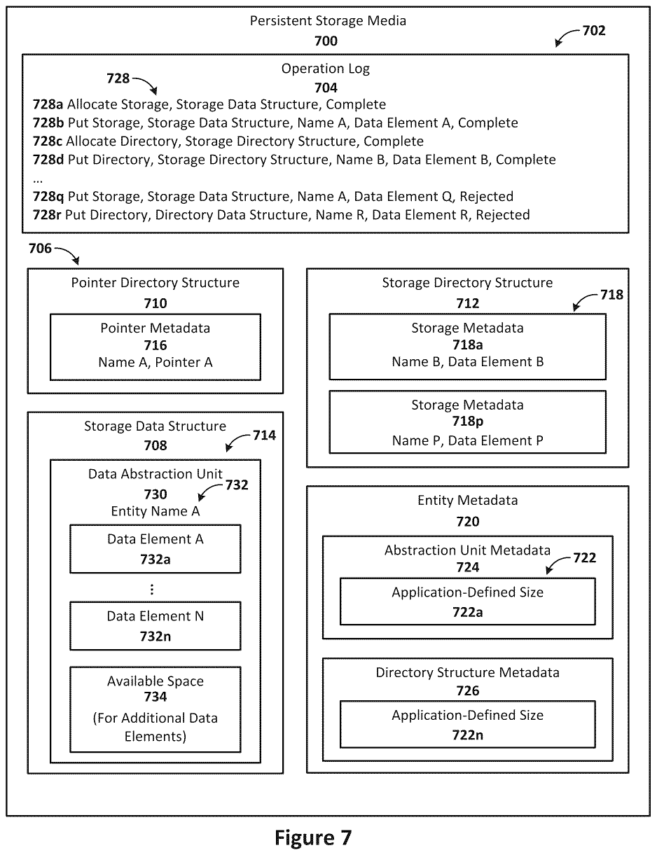

As shown in FIG. 6, the system 600 includes one or more persistent storage media 618 and one or more transient storage media 620. The term “persistent storage media” refers to storage devices or systems that retain data independent from availability of electrical power. Persistent storage media may also be referred to as “non-volatile media.” The term “transient storage media” refers to storage devices or systems that rely on continuous provision of electrical power to maintain data. Transient storage media may also be referred to as “volatile media.” Multiple data structures may be stored on the one or more persistent storage media 618. As shown in FIG. 6, the persistent storage media 618 may include one or more of the following data structures: an operation log 622, a directory data structure 626, or a storage data structure 628. Example data structures of the persistent storage media 618 are further described below with reference to FIG. 7.

The operation log 622 includes log entries that are stored in the operation log 622 when the file system 606 executes logging operations. The logging operations include writing data to log entries stored in the operation log 622 in connection with target operations requested by the application 602. In one example, logging operations include storing data in the persistent storage media 618 and/or in the transient storage media 620 in connection with the log entries stored in the operation log 622. The log entries stored in the operation log 622 may include identifier elements that identify a target operation and a target entity associated with the target operation. The target entity may include a data abstraction unit or a data structure associated with a data abstraction unit. In one example, the log entries include a status of the target operation, such as an indication as to whether the target operation is complete or incomplete. The identifier elements stored in the operations log 622 may include a key-value pair. A key of the key-value pair may include a name of the target entity. A value of the key-value pair may include a pointer that points to a location of a file or data element stored in relation to the target entity, such as in the persistent storage media 618 and/or in the transient storage media 620. Additionally, or alternatively, the value of the key-value pair may include data associated with the target operation, such as data to be written, uploaded, or inserted with respect to the target entity and/or data representing a modification to be executed with respect to the target entity. In one example, the file system 606 stores a log entry in the operation log 622 that includes data associated with the target operation in response to a request from the application provided via the put data API. Additionally, or alternatively, in response to a request from the application 602 provided via the put pointer API, the file system 606 stores (a) data associated with the target operation in the transient storage media 620 and (b) a log entry in the operation log 622 that includes a pointer that points to the data stored in the persistent storage media 618 and/or in the transient storage media 620. At a point in time after executing one or more logging operations, the file system 606 traverses the operation log 622 to execute target operations corresponding to one or more log entries in the operation log 622.

The directory data structure 626 includes one or more directories 630, such as directory 630a and directory 630n. The directories 630 may include an index that the file system utilizes to access files and/or data elements. The directories 630 may include multiple subdirectories. A directory 630 may include a hierarchical data structure such as a hierarchical tree structure. Example hierarchical data structures include B− trees and B+ trees. B− trees provide a balanced, hierarchical indexing that facilitates efficient search, insertion, and deletion operations, even with large datasets. B+ trees are a variant of a B− tree that stores keys in intermediate nodes and data elements in leaf nodes to facilitate efficient access to the data elements.

The storage data structure 628 includes one or more sets of data blocks 632, such as data blocks 632a and data blocks 632n. The data blocks 632 are units of storage on a storage medium that are utilized to store data elements, such as files or portions of files. The data blocks 632 may have a defined size determined, for example, based on configuration information of the file system 606. Files that are larger than a single data block 632 are distributed across multiple data blocks 632 that may have a contiguous or dispersed location on one or more storage media. The directories 630 may include metadata that is utilized by the file system 606 to track the mapping of data elements or files to corresponding data blocks 632.

The transient storage media 620 includes at least one cached directory data structure 634 and/or at least one cached storage data structure 636. A cached directory data structure 634 includes a cached version of a directory data structure 626. A cached storage data structure 636 includes a cached version of a storage data structure 628. The file system 606 utilizes one or more cached directory data structures 634 and/or one or more cached storage data structure 636 to store data elements corresponding to recent target operations. A cached directory data structure 634 may represent an in-memory copy of a directory data structure 626. A cached storage data structure 636 may represent an in-memory copy of a storage data structure 628. Changes to a cached directory data structure 634 are persisted to a directory data structure 626 corresponding to the cached directory data structure 634, for example, on a periodic basis. Additionally, or alternatively, changes to a cached storage data structure 636 are persisted to a storage data structure 628 corresponding to the cached storage data structure 636, for example, on a periodic basis. In one example, in response to a request from an application 602 to execute a target operation, the file system 606 executes a logging operation and a caching operation. The logging operation includes writing metadata to a log entry of an operation log 622 stored in persistent storage media 618. The caching operation includes executing the target operation in the transient storage media 620. The metadata written to the log entry in the operation log 622 includes sufficient data that the file system 606 to execute the target operation in the persistent storage media 618 corresponding to the log entry. The file system 606 can execute the target operation in the persistent storage media 618 without utilizing or referring to data in the transient storage media 620. In the event of a file system crash where data corresponding to a target operation in the transient storage media 620 is lost or compromised, the file system 606 can execute the target operation in the persistent storage media 618 based on the log entry in the operation log 622 corresponding to the target operation. In one example, in addition to the logging operation and the caching operation, the file system 606 may store a data element in one or more data blocks 632 of the storage data structure 628 in persistent storage media 618. The metadata stored in the log entry of the operation log 622 may include a pointer to a location of the data element in the storage data structure 628. Later, the file system 606 may update a directory 630 of the directory data structure 626 in the persistent storage media 618 to include a pointer that points to the location of the data element in the storage data structure 628. Storing the data element in the one or more data blocks 632 of the storage data structure 628 in the persistent storage media 618 may represent a portion of the target operation. Updating the directory 630 of the directory data structure 626 in the persistent storage media 618 may represent an additional portion of the target operation. Completion of the target operation in the persistent storage media 618 may include (a) storing the data element in the one or more data blocks 632 of the storage data structure 628 and (b) updating the directory 630 of the directory data structure 626.

In one or more embodiments, the data structures associated with the file system 606 may include any type of storage unit and/or device (e.g., a file system, database, collection of tables, or any other storage mechanism) for storing data. Furthermore, the data structures may include multiple different storage units and/or devices. The multiple different storage units and/or devices may or may not be of the same type or located at the same physical site. Furthermore, a data structure may be implemented or executed on the same computing system as the file system 606 and/or on the same computing system as the application 602. Additionally, or alternatively, a data structure may be implemented or executed on a computing system that is separate from the file system 606 and/or the application 602. The data structures, the file system 606, and/or the application 602 may be communicatively coupled to one another via a direct connection or via a network.

Referring further to FIG. 6, the system 600 may include a user device interface 638 communicatively coupled or couplable with the application 602 and/or one or more other components of the system 600. A user device interface 638 may include hardware and/or software configured to facilitate interactions between a user and various aspects of the system 600. The user device interface 638 may render user interface elements and receive input via user interface elements. For example, the user device interface 638 may display outputs generated by the application 602. Additionally, or alternatively, the user device interface 638 may be configured to provide inputs to the application 602. Examples of interfaces include a graphical user interface (GUI), a command line interface (CLI), a haptic interface, or a voice command interface. Examples of user interface elements include checkboxes, radio buttons, dropdown lists, list boxes, buttons, toggles, text fields, date and time selectors, command lines, sliders, pages, or forms. Any one or more of these interfaces or interface elements may be utilized by a user device interface 638.

In an embodiment, different components of a user device interface 638 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, a user device interface 638 may be specified in one or more other languages, such as Java, C, or C++.

Additionally, or alternatively, the system 600 may include one or more communications interfaces 640 communicatively coupled or couplable with the application 602 and/or one or more other components of the system 600. The one or more communications interfaces 640 may include hardware and/or software configured to transmit data between respective components of the system 600 and/or to transmit data to and/or from the system 600. For example, a communications interface 640 may transmit and/or receive data between and/or among one or more of the following: the application 602, the file system APIs 604, the file system 606, one or more persistent storage media 618, one or more transient storage media 620, and/or one or more user device interfaces 638.

In one example, the system 600 may be implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a browser device.

### B. Example File System Data Structures

Referring to FIG. 7, example file system data structures are further described. As shown in FIG. 7, one or more persistent storage media 700 include one or more data structures 702 associated with a file system. The persistent storage media 618 described above with reference to FIG. 6 may include one or more data structures 702 of the persistent storage media 700 described below with reference to FIG. 7. As shown in FIG. 7, the one or more persistent storage media 700 may include one or more of the following: an operation log 704, one or more directory data structures 706, or one or more storage data structure 708. The one or more directory data structures 706 of the persistent storage media 700 may include one or more pointer directory structures 710 and/or one or more storage directory structures 712.

A pointer directory structure 710 is a hierarchical data structure, such as a B− tree, that includes pointers that point to data abstraction units (e.g., data elements or files) stored in the storage data structure 708. The storage data structure 708 includes one or more data abstraction units 714 stored in one or more data blocks of the storage data structure 708. The pointers of the pointer directory structure 710 point to locations of data abstraction units 714 in the storage data structure 708.

In one example, a pointer directory structure 710 includes pointer metadata 716. The pointer metadata 716 includes a key-value pair. A key of the key-value pair may include a name of a target entity, such as a name of a data abstraction unit. A value of the key-value pair may include a pointer that points to a location of the target entity, such as a file or a portion of a file, in the storage data structure 708. The pointer metadata 716 may be stored in a node of the hierarchical data structure such as in a leaf node of a B− tree.

A storage directory structure 712 is a hierarchical data structure, such as a B+tree, that includes data abstraction units stored as storage metadata 718 in the hierarchical data structure. The storage metadata 718 includes a key-value pair. A key of the key-value pair may include a name of a target entity, such as a name of a data abstraction unit. A value of the key-value pair may include a data abstraction unit. The storage metadata 718 may be stored in a node of the hierarchical data structure, such as in a leaf node of a B+ tree.

In one example, the persistent storage media 700 includes entity metadata 720. The entity metadata 720 includes metadata corresponding to one or more particular target entities, such as metadata corresponding to one or more data abstraction units 714, one or more storage data structures 708, and/or one or more directory data structures 706. As shown in FIG. 7, the entity metadata 720 includes one or more application-defined sizes 722 corresponding to one or more target entities. In one example, the entity metadata 720 may include abstraction unit metadata 724 with metadata corresponding to one or more files. The abstraction unit metadata 724 may include application-defined size 722a corresponding to one or more files stored in the storage data structure 708. Additionally, or alternatively, the entity metadata 720 may include directory structure metadata 726 with metadata corresponding to one or more directory data structures. The directory structure metadata 726 may include application-defined size 722n corresponding to one or more directory data structures 706.

In one example, the persistent storage media 700 includes an operation log 704. The operation log 704 includes a set of log entries 728. The file system executes logging operations that include writing data to the log entries 728 in the operation log 704. Additionally, the file system executes target operations that include traversing the operation log 704 to identify log entries 728 corresponding to target operations and executing the target operations. The file system may identify a target operation in the operation log 704 as “complete” or “incomplete” depending on whether or not the file system has completed execution of the target operation.

Log entry 728a includes an operation type-identifier (Allocate Data) that serves as an indicator for one or more target operations. Additionally, log entry 728a includes a target entity-identifier (Storage Data Structure) that serves as an indicator for a target entity corresponding to the one or more target operations. The one or more target operations corresponding to the operation type-identifier of “Allocate Data” include allocating a data structure for storing data associated with a target entity. Additionally, or alternatively, the one or more target operations corresponding to the operation type-identifier of “Allocate Data” may include storing an application-defined size, for example, in entity metadata 720, that represents a size of data stored in the data structure. Log entry 728a has a status of “complete.” As shown in FIG. 7, the storage data structure 708 includes data abstraction unit 730. The file system allocated at least a portion of the storage data structure 708 of data abstraction unit 730 when executing the one or more target operations corresponding to log entry 728a. Additionally, the file system stored application-defined size 722a corresponding to data abstraction unit 730 in abstraction unit metadata 724 when executing the one or more target operations corresponding to log entry 728a.

Log entry 728b includes an operation type-identifier (Put Storage) that serves as an indicator for one or more target operations. Additionally, log entry 728b includes a target entity-identifier (Storage Data Structure) that serves as an indicator for a target entity corresponding to the one or more target operations. The one or more target operations corresponding to the operation type-identifier of “Put Storage” include storing a data element (Data Element A of Filename A) in the storage data structure 708 in relation to a data abstraction unit 730 and storing pointer metadata 716 in the pointer directory structure 710 to identify the location of the data abstraction unit 730 in the storage data structure 708. Log entry 728b has a status of “complete.” As shown in FIG. 7, data abstraction unit 730 in storage data structure 708 includes data element 732a, and pointer metadata 716 includes a key-value pair (Filename A, Pointer A). The key of the key-value pair includes a name of a target entity (Filename A) such as a name of data abstraction unit 730. The value of the key-value pair includes a pointer (Pointer A) that points to a location of the target entity such as a location of data abstraction unit 730 in the storage data structure 708. When performing the one or more target operations associated with storing data element 732a in the storage data structure 708, the file system verified that storing data element 732a satisfies application-defined size 722a corresponding to data abstraction unit 730. The file system stored data element 732 in the storage data structure 708 based on determining that the application-defined size 722a is satisfied. Additionally, or alternatively, the pointer metadata 716 in the pointer directory structure 710 based on determining that the application-defined size 722a is satisfied. As shown in FIG. 7, Data abstraction unit 730 additionally includes data element 732n that the file system stored in data abstraction unit 730 of storage data structure 708 based on determining that the application-defined size 722a is satisfied. As shown in FIG. 7, the storage data structure 708 includes available space 734. Available space 734 may represent a difference between (a) the size of the data elements 732 of data abstraction unit 730 stored in the storage data structure 708 and (b) the application-defined size 722a for data abstraction unit 730. The file system may utilize the available space 734 to store additional data elements 732 of data abstraction unit 730.

Log entry 728c includes an operation type-identifier (Allocate Directory) that serves as an indicator for one or more target operations. Additionally, log entry 728c includes a target entity-identifier (Storage Directory Structure) that serves as an indicator for a target entity corresponding to the one or more target operations. The one or more target operations corresponding to the operation type-identifier of “Allocate Directory” include allocating a directory data structure 706 for storing data abstraction units as storage metadata 718. Additionally, or alternatively, the one or more target operations corresponding to the operation type-identifier of “Allocate Directory” may include storing an application-defined size, for example, in entity metadata 720, that represents a size of a data abstraction unit stored in the directory data structure 706. Log entry 728c has a status of “complete.” As shown in FIG. 7, the persistent storage media 700 includes storage directory structure 712. The file system allocated at least a portion of storage directory structure 712 when executing the one or more target operations corresponding to log entry 728c. Additionally, the file system stored application-defined size 722n corresponding to the storage metadata 718 stored in the storage directory structure 712 when executing the one or more target operations corresponding to log entry 728c.

Log entry 728d includes an operation type-identifier (Put Directory) that serves as an indicator for one or more target operations. Additionally, log entry 728d includes a target entity-identifier (Storage Directory Structure) that serves as an indicator for a target entity corresponding to the one or more target operations. The one or more target operations corresponding to the operation type-identifier of “Put Directory” include storing a data abstraction unit 730 (Data Element B) as storage metadata 718 in the storage directory structure 712. Log entry 728d has a status of “complete.” As shown in FIG. 7, storage metadata 718a in storage directory structure 712 includes a key-value pair (Name B, Data Element B). The key of the key-value pair includes a name of a target entity (Name B). The value of the key-value pair includes a data abstraction unit of the target entity (Data Element B). When performing the one or more target operations associated with storing storage metadata 718a in the storage data structure 708, the file system verified that storing storage metadata 718a satisfies application-defined size 722n corresponding to storage metadata 718 stored in the storage directory structure 712. The storage metadata 718a in the storage directory structure 712 based on determining that the application-defined size 722n is satisfied. As shown in FIG. 7, storage directory structure 712 additionally includes storage metadata 718p that the file system stored in storage directory structure 712 based on determining that the application-defined size 722n is satisfied.

As further shown in FIG. 7, the operation log 704 may include one or more log entries 728 corresponding to target operations that were rejected based on an application-defined size 722. Additionally, or alternatively, target operations may be rejected based on an application-defined size prior to being stored in log entries 728 of the operation log 704. Log entry 728q includes an operation type-identifier (Put Storage) that serves as an indicator for one or more target operations. Additionally, log entry 728q includes a target entity-identifier (Storage Data Structure) that serves as an indicator for a target entity corresponding to the one or more target operations, such as storing a data element (Data Element Q) in relation to data abstraction unit 730 in the storage data structure 708 and storing pointer metadata 716 in the pointer directory structure 710 to identify the location of the data abstraction unit in the storage data structure 708. Log entry 728q has a status of “rejected.” In one example, the file system determines that executing the one or more target operations, such as storing data element Q in relation to data abstraction unit 730, would exceed the application-defined size 722a corresponding to data abstraction unit 730. In one example, the size of data element Q may exceed the size of the available space 734 for data abstraction unit 730 in the storage data structure 708. Based on determining that the one or more target operations would exceed the application-defined size 722a, the file system rejected the one or more target operations corresponding to log entry 728q. The file system may execute one or more operations in response to rejecting the one or more target operations corresponding to log entry 728q. The one or more operations executed by the file system in response to rejecting the one or more target operations corresponding to log entry 728q may include setting the status of log entry 728q to “rejected.” In one example, the file system may transmit a notification to the application that the one or more target operations corresponding to log entry 728q are rejected. The application may request additional target operations in response to the notification from the file system. In one example, the application may request the file system to allocate additional space in the storage data structure 708 for data abstraction unit 730. Additionally, or alternatively, the application may request the file system to update application-defined size 722a corresponding to data abstraction unit 730. Additionally, or alternatively, the application may request the file system to allocate an additional storage data structure and/or to allocate additional space in storage data structure 708 for an additional data abstraction unit. The application may request the file system to store an additional application-defined size corresponding to the additional data abstraction unit.

Log entry 728r includes an operation type-identifier (Put Directory) that serves as an indicator for one or more target operations. Additionally, log entry 728r includes a target entity-identifier (Storage Directory Structure) that serves as an indicator for a target entity corresponding to the one or more target operations, such as storing a data abstraction unit (Data Element R) as storage metadata 718 in the storage directory structure 712.

Log entry 728r has a status of “rejected.” In one example, the file system determines that executing the one or more target operations, such as storing a data element R as a data abstraction unit in storage metadata 718 in the storage directory structure 712, would exceed the application-defined size 722n corresponding to storage metadata 718 in the storage directory structure 712. Based on determining that the one or more target operations would exceed the application-defined size 722n, the file system rejected the one or more target operations corresponding to log entry 728r. The file system may execute one or more operations in response to rejecting the one or more target operations corresponding to log entry 728r. The one or more operations executed by the file system in response to rejecting the one or more target operations corresponding to log entry 728r may include setting the status of log entry 728r to “rejected.” In one example, the file system may transmit a notification to the application that the one or more target operations corresponding to log entry 728r are rejected. The application may request additional target operations in response to the notification from the file system. In one example, the application may request the file system to store data element R in relation to a different data abstraction unit in storage data structure 708 rather than as storage metadata 718 in the storage directory structure 712. Additionally, or alternatively, the application may request the file system to update application-defined size 722n corresponding to storage metadata 718 in the storage directory structure 712. Additionally, or alternatively, the application may request the file system to allocate an additional storage directory structures and/or to allocate additional space for storage metadata 718 in the storage directory structure 712. The application may request the file system to store an additional application-defined size corresponding to the additional storage directory structures.

### 5. Example Operations Associated with a File System

Referring now to FIG. 8, example operations 800 associated with a file system are further described. One or more operations described with reference to FIG. 8 may be modified, rearranged, or omitted. Accordingly, the particular sequence of operations described with reference to FIG. 8 should not be construed as limiting the scope of one or more embodiments. In one example, the operations described with reference to FIG. 8 may be performed by one or more features of the system described with reference to FIG. 6. As described with reference to FIG. 8, a file system determines whether to grant or deny requests to execute target operations that include storing data elements in relation to a data abstraction unit based on whether or not the request to execute the target operation satisfies an application-defined size.

As shown in FIG. 8, a file system receives, from an application, a request to allocate a data structure for storing data elements in relation to a data abstraction unit (Operation 802). In one example, request specifies an application-defined size assigned by the application to the data abstraction unit. Additionally, or alternatively, the application may indirectly assign an application-defined size limit by initiating a request to allocate a data structure for storing data elements in relation to a data abstraction unit without explicitly specifying the application-defined size. When the file system receives a request from an application to allocate a data structure for storing data elements in relation to a data abstraction unit that does not explicitly specifying the application-defined size, the application interprets the request as the application assigning a pre-defined size to the data abstraction unit. The file system may receive the request from the application via an API utilized by the application to send requests to the file system. In response to the request from the application, the file system allocates the data structure in one or more persistent storage media (Operation 804). To allocate the data structure in the one or more persistent storage media, the file system determines the application-defined size assigned to the data abstraction unit and then reserves disk space, e.g., contiguous disk space, for storing data elements in relation to the data abstraction unit. Additionally, in response to the request from the application, the file system stores the application-defined size in the one or more persistent storage media (Operation 806). The file system may store the application-defined size in metadata associated with the data abstraction unit and/or the data structure.

In one example, to allocate the data structure, the file system may divide the one or more persistent storage media into one or more partitions. The file system may format the one or more partitions and initialize the one or more partitions with a specific data structure. The file system may determine a size of the one or more partitions based on the application-defined size. The data structure may include a storage data structure and/or a directory data structure. In one example, when the data structure is a storage data structure, the file system may generate a directory data structure associated with the storage data structure. The directory data structure may be utilized to store metadata associated with the storage data structure. The metadata may include pointers to locations of data abstraction units stored in the storage data structure. In one example, the file system divides the data structure into blocks or clusters for efficient storage. The file system allocates a set of blocks or clusters for storing data elements in relation to a data abstraction unit and updates metadata to map the blocks or clusters to physical locations of the one or more persistent storage media. Additionally, or alternatively, in response to the request from the application, the file system may allocate a pre-existing data structure of the persistent storage media for storing data elements in relation to a data abstraction unit. The file system may identify available blocks or clusters, for example, using a free space bitmap or a free space list. The file system may allocate contiguous blocks or clusters to minimize fragmentation.

After allocating the data structure for storing data elements in relation to a data abstraction unit and storing the application-defined size associated with the data abstraction unit, the file system receives one or more requests to execute a target operation that includes storing one or more data elements in relation to the data abstraction unit. The file system may receive multiple requests to execute a target operation that includes storing one or more data elements in relation to the data abstraction unit. In one example, the file system receives a request to execute a target operation that includes storing one or more data elements in relation to the data abstraction unit concurrently with the request to allocate the data structure. Additionally, or alternatively, the file system may receive the one or more requests after allocating the data structure.

As shown in FIG. 8, the file system receives, from an application, a request to execute a target operation that includes storing a data element in relation to the data abstraction unit (Operation 808). The file system may receive the request from the application via an API utilized by the application to send requests to the file system. In response to the request from the application, the file system determines the application-defined size assigned to the data abstraction unit (Operation 810). The file system may access the application-defined size in metadata associated with the data abstraction unit.

The file system determines whether the request to execute the target operation satisfies the application-defined size (Operation 812). The file system may determine whether storing the data element in relation to the data abstraction unit satisfies the application-defined size. The file system may determine whether executing the target operation satisfies the application-defined size by determining whether executing the target operation results in exceeding an available size of a physical disk space, such as a contiguous physical disk space, that is reserved for storing data elements in relation to the data abstraction unit. The file system may determine whether the request to execute the target operation satisfies the application-defined size by comparing the size of the data element to the size of available space within the application-defined size that is not already occupied by other data elements. In one example, the file system determines whether the storage of the data element in relation to the data abstraction unit would exceed the application-defined size. In one example, the file system determines that the request to execute the target operation satisfies the application-defined size based on the application-defined size being greater than a combination of (a) an element size of the data element and (b) a size of zero or more data elements stored in the data structure in relation to the data abstraction unit. Additionally, or alternatively, the file system may determine that the request to execute the target operation does not satisfy the application-defined size based on the application-defined size being less than a combination of (a) the element size of the data element and (b) the size of zero or more data elements stored in the data structure in relation to the data abstraction unit. In one example, the file system determines the size of the zero or more data elements stored in the data structure in relation to the data abstraction unit based on metadata associated with the data structure. Additionally, or alternatively, the file system may determine whether the request to execute the target operation satisfies the application-defined size based one or more log entries in an operation log corresponding to one or more data elements that have yet to be stored in the data structure. The one or more log entries may include metadata that identifies a size of the data elements that have yet to be stored in the data structure. The one or more data elements may correspond to one or more previous requests to execute one or more target operations. The file system may have granted the one or more previous requests and recorded metadata in the operation log for reference when executing the one or more target operations at a later time.

When the file system determines that the request to execute the target operation satisfies the application-defined size, the file system grants the request to execute the target operation (Operation 814). The file system may grant the request by returning a success code or identifier. When the file system grants the request to execute the target operation, the file system performs one or more operations associated with and/or including executing the target operation (Operation 816). In one example, the file system executes the target operation, including storing the data element in the data structure in relation to the data abstraction unit. Additionally, or alternatively, the file system may execute a logging operation that includes writing metadata to a log entry of an operation log stored in the one or more persistent storage media. The file system may reference the metadata written to the operation log when executing the target operation at a later time. After writing the metadata to the operation log, the file system may execute the target operation based on the metadata. In one example, the file system transmits a response to the application, indicating that the request to execute the target corporation is granted. Additionally, or alternatively, the file system may determine that execution of the logging operation is complete and transmits a response to the application based on completion of the logging operation. In one example, the file system may update the size of the zero or more data elements in metadata to reflect the element size of the data element corresponding to the target operation. The file system may update the size of the zero or more data elements in metadata prior to executing the target operation, for example, so the metadata can be utilized in determining whether to grant or reject subsequent requests. In one example, the metadata includes the size of one or more data elements corresponding to log entries in the operation log for target operations that have yet to be completed.

When the file system determines that the request to execute the target operation does not satisfy the application-defined size, the file system rejects the request to execute the target operation (Operation 818). The file system may reject the request by returning a rejection code or identifier. When the file system rejects the request to execute the target operation, the file system performs one or more operations associated with rejecting the request to execute the target operation (Operation 820). The one or more operations include refraining from executing the target operation. Additionally, or alternatively, the one or more operations may include generating and transmitting a response to the application. The response may indicate that the request is rejected. Additionally, or alternatively, the response may indicate that the additional data element will exceed the application-defined size.

### 6. Miscellaneous; Extensions

Embodiments are directed to a system with one or more devices that include a hardware processor and that are configured to perform any of the operations described herein and/or recited in any of the claims below. Embodiments are directed to a system that includes means to perform any of the operations described herein and/or recited in any of the claims below. In an embodiment, a non-transitory, computer-readable storage medium comprises instructions that, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. Accordingly, the specification and drawings are to be regarded in an illustrative rather than a restrictive sense. The sole and exclusive indicator of the scope of patent protection, and what is intended by the applicants to be the scope of patent protection, is the literal and equivalent scope of the set of claims that issue from this application in the specific form that such claims issue, including any subsequent correction.

References, including publications, patent applications, and patents, cited herein are hereby incorporated by reference to the same extent as if the references were individually and specifically indicated to be incorporated by reference and were set forth in entirety herein.

1. A method, comprising:
receiving, by a file system from an application via an operating system, a first request to execute a first target operation comprising storing a first data element in relation to a first data abstraction unit of a plurality of data abstraction units maintained by the file system for storing application data corresponding to the application;
determining, by the file system, that storing the first data element in relation to the first data abstraction unit would result in a first aggregate size corresponding to the first data abstraction unit exceeding a first application-defined size assigned to the first data abstraction unit;
responsive to determining that storing the first data element in relation to the first data abstraction unit would result in the first aggregate size exceeding the first application-defined size, rejecting, by the file system, the first request from the application;
wherein the method is performed by at least one device including a hardware processor.

2. The method of claim 1, further comprising:
based at least on rejecting the first request: transmitting, to the application, a response to the first request indicating that the first request is rejected.

3. The method of claim 1, further comprising:
based at least on rejecting the first request: refraining from executing the first target operation.

4. The method of claim 1, wherein the first aggregate size corresponding to the first data abstraction unit comprises a first size of the first data element and a second size of one or more additional data elements already stored in relation to the first data abstraction unit.

5. The method of claim 1, wherein the first target operation comprises storing the first data element in a data structure that has been allocated for storing data elements in relation to the first data abstraction unit.

6. The method of claim 1, wherein determining that storing the first data element in relation to the first data abstraction unit would result in the first aggregate size corresponding to the first data abstraction unit exceeding the first application-defined size assigned to the first data abstraction unit comprises:
determining that the application-defined size is less than a combination of (a) a first size of the first data element and (b) a size of zero or more data elements currently stored in relation to the first data abstraction unit.

7. The method of claim 1, further comprising:
receiving, from the application, a second request to execute a second target operation comprising storing a second data element in relation to a second data abstraction unit;
determining that storing the second data element in relation to the second data abstraction unit would result in a second aggregate size corresponding to the second data abstraction unit being less than a second application-defined size assigned to the second data abstraction unit;
responsive to determining that storing the first data element in relation to the first data abstraction unit would result in the second aggregate size being less than the first application-defined size, granting the second request;
responsive to granting the second request, initiating execution of the second target operation comprising storing the second data element in relation to the second data abstraction unit.

8. The method of claim 7, wherein initiating execution of the second target operation comprises:
executing a logging operation comprising writing metadata to a log entry of an operation log stored in one or more persistent storage media, wherein the second target operation is executed based on the metadata.

9. The method of claim 8, further comprising:
subsequent to executing the logging operation:
determining that execution of the logging operation is complete;
transmitting, to the application, a response to the second request that is based on completion of the logging operation, the logging operation being different than the second target operation.

10. The method of claim 8, further comprising:
subsequent to executing the logging operation: performing one or more additional operations to execute the second target operation.

11. The method of claim 7, further comprising:
determining a second element size of the second data element based at least in part on the second request;
determining a size of the zero or more data elements already stored in relation to the second data abstraction unit;
determining that the second application-defined size is greater than the combination of the second element size of the second data element and the size of the zero or more data elements already stored in relation to the second data abstraction unit;
determining that the second element size of the second data element satisfies the second application-defined size based at least on the second application-defined size being greater than the combination of the second element size of the second data element and the size of the zero or more data elements already stored in relation to the second data abstraction unit.

12. The method of claim 11, further comprising:
updating, in metadata associated with the first data abstraction unit, the size of the zero or more data elements already stored in relation to the second data abstraction unit to reflect the second element size of the second data element.

13. The method of claim 12, further comprising:
updating the size of the zero or more data elements already stored in relation to the second data abstraction unit prior to storing the second data element in relation to the second data abstraction unit.

14. The method of claim 7, further comprising:
subsequent to granting the second request:
receiving, from the application, a third request to execute a third target operation comprising storing a third data element in relation to the second data abstraction unit;
determining the second application-defined size assigned to the second data abstraction unit;
determining that storing the third data element in relation to the second data abstraction unit would result in the second aggregate size corresponding to the second data abstraction unit being greater than the second application-defined size assigned to the second data abstraction unit;
responsive to determining that storing the third data element in relation to the second data abstraction unit would result in the second aggregate size being greater than the second application-defined size, rejecting the third request.

15. The method of claim 14, further comprising:
determining a second element size of the second data element based at least in part on a log entry of an operation log stored in one or more persistent storage media, the log entry comprising metadata written at least by executing a logging operation responsive to granting the second request;
determining a size of the zero or more data elements already stored in relation to the second data abstraction unit;
determining a third element size of the third data element based at least in part on the third request;
determining that the second application-defined size is less than the combination of the third element size of the third data element, the second element size of the second data element, and the size of the zero or more data elements already stored in relation to the second data abstraction unit;
determining that storing the third data element in relation to the second data abstraction unit would exceed the second application-defined size based at least on the second application-defined size being less than the combination of the third element size of the third data element, the second element size of the second data element, and the size of the zero or more data elements already stored in relation to the second data abstraction unit.

16. The method of claim 1, further comprising:
prior to receiving the first request from the application:
receiving from the application, the first application-defined size assigned to the first data abstraction unit;
storing the application-defined size in metadata.

17. The method of claim 16, further comprising:
responsive at least in part to receiving the application-defined size, allocating a set of memory blocks of a data structure for storing data elements in relation to the first data abstraction unit.

18. The method of claim 16, wherein the first data abstraction unit comprises a logical abstraction representing a unit of data that includes one or more data elements.

19. The method of claim 1, wherein determining that storing the first data element in relation to the first data abstraction unit would result in the first aggregate size exceeding the first application-defined size comprises:
determining that storing the first data element in a contiguous physical disk space reserved for storing data elements in relation to the data abstraction unit exceeds an available size of the contiguous physical disk space.

20. One or more non-transitory computer-readable media comprising instructions that, when executed by one or more hardware processors, cause performance of operations comprising:
receiving, by a file system from an application via an operating system, a first request to execute a first target operation comprising storing a first data element in relation to a first data abstraction unit of a plurality of data abstraction units maintained by the file system for storing application data corresponding to the application;
determining, by the file system, that storing the first data element in relation to the first data abstraction unit would result in a first aggregate size corresponding to the first data abstraction unit exceeding a first application-defined size assigned to the first data abstraction unit;
responsive to determining that storing the first data element in relation to the first data abstraction unit would result in the first aggregate size exceeding the first application-defined size, rejecting, by the file system, the first request from the application.

21. A system comprising:
at least one device including a hardware processor;
the system being configured to perform operations comprising:
receiving, by a file system from an application via an operating system, a first request to execute a first target operation comprising storing a first data element in relation to a first data abstraction unit of a plurality of data abstraction units maintained by the file system for storing application data corresponding to the application;
determining, by the file system, that storing the first data element in relation to the first data abstraction unit would result in a first aggregate size corresponding to the first data abstraction unit exceeding a first application-defined size assigned to the first data abstraction unit;
responsive to determining that storing the first data element in relation to the first data abstraction unit would result in the first aggregate size exceeding the first application-defined size, rejecting, by the file system, the first request from the application.
